(19) United States
(12) Patent Application Publication
(10) Pub. No.: US 2014/0044436 A1
(43) Pub. Date: Feb. 13, 2014

(54) OPTICAL TRANSMITTER AND OPTICAL TRANSCEIVER COMPRISING OPTICAL TRANSMITTER

(71) Applicant: Electronics and Telecommunications Research Institute, Daejeon (KR)

(72) Inventors: Jie Hyun LEE, Daejeon (KR); Seung Hyun CHO, Daejeon (KR); Kyeong Hwan DOO, Daejeon (KR); Seung Il MYONG, Daejeon (KR)

(73) Assignee: Electronics and Telecommunications Research Institute, Daejeon (KR)

(21) Appl. No.: 13/962,292

(22) Filed: Aug. 8, 2013

(30) Foreign Application Priority Data
Aug. 9, 2012 (KR) 10-2012-0087415
Jul. 26, 2013 (KR) 10-2013-0088948

(51) Int. Cl. H04B 10/40

(52) U.S. Cl. CPC H04B 10/40
USPC 398/135; 398/201

(57) ABSTRACT

An optical transmitter and an optical transceiver including the same are provided. The optical transmitter may include a semiconductor laser diode to output optical signals, a multilayer thin film filter to receive the optical signals and pass optical signals corresponding to a transmission wavelength band, and a concave lens to collect the optical signals passed through the multilayer thin film filter.

### CROSS-REFERENCE TO RELATED APPLICATIONS

This application claims the benefit of Korean Patent Application No. 10-2012-0087415 filed on Aug. 9, 2012 and Korean Patent Application No. 10-2013-0088948 field on Jul. 26, 2013, in the Korean Intellectual Property Office, the disclosures of which are incorporated herein by reference.

### BACKGROUND

1. Field of the Invention

The present invention relates to an optical transmitter and an optical transceiver including the optical transmitter, and more particularly, to an optical transmitter based on a multilayer thin film filter and an optical transceiver capable of transmitting and receiving light bi-directionally using the optical transmitter.

2. Description of the Related Art

In operation of a mobile backhaul/fronthaul for supporting a wired subscriber network or a separate base station, and a wired or wireless integrated subscriber network, system performance is determined by an optical communication module and optical parts. In particular, an optical sub-assembly (OSA), which is a core part in charge of optical electrical conversion or electrical optical conversion, may be divided according to use into a transmitter optical sub-assembly (TOSA), a receiver optical sub-assembly (ROSA), and a bi-directional optical sub-assembly (BOSA).

In particular, the BOSA is a bi-directinal optical transceiver capable of both receiving and transmitting signals of same or different wavelengths using a single optical fiber. The BOSA may increase a degree of integration by enabling size reduction of a product and may reduce a price of the product. The BOSA includes an optical filter that separates an optical transmission module and a reception module from each other, and a transmitted signal and a received signal from each other. An edge filter, a bandpass filter, or a tap filter may be used as the optical filter in consideration of the transmitted signal, the received signal, and crosstalk. Optical functions such as an output wavelength and a light intensity, and the price of the BOSA are determined by a light source used as the transmission module.

Recently, excessive traffic is induced in a wired and wireless network due to appearance of portable multifunctional devices. To efficiently cope with the excessive traffic, a wavelength division multiplexing (WDM) method for the wired subscriber network or a wired and wireless integrated subscriber network is being researched. The WDM refers to a transceiving technology that multiplexes a plurality of optical wavelengths to a single optical fiber. According to the WDM, line cost may be reduced as many as a number of wavelengths received in the single optical fiber. Furthermore, since channels are separated by the optical wavelength, security, quality of service (QoS), and protocol transparency are relatively high in comparison to other technologies.

However, different wavelengths are necessary to be assigned to each optical line terminal (OLT) for utilization of the WDM. Therefore, an optical transceiver is demanded, which has an intrinsic wavelength equivalent to a number of subscribers of the wired subscriber network split at a remote node or a number of separate base stations used in the wired and wireless integrated network. Thus, since a number of WDM light sources is increased corresponding to a number of optical subscriber devices, according to the WDM, a demand for a low price WDM light source is increasing for reduction of the entire system cost. In addition, the output wavelength needs to be stably maintained to prevent inter-channel crosstalk.

### SUMMARY

An aspect of the present invention provides an optical transmitter including a downsized external resonance laser based on a multilayer thin film filter, and an optical transceiver including the same.

Another aspect of the present invention provides an optical transmitter capable of securing a modulation bandwidth for an external resonance laser based on a multilayer thin film filter, by downsizing the external resonance laser, and an optical transceiver including the same.

Still another aspect of the present invention provides an optical transmitter used as a low price optical transceiver in a wired network optical subscriber terminal or a separate base station of a wired and wireless integrated network, by packaging an optical transmitter including an external resonance laser based on a multilayer thin film filter and an optical receiver together so that bi-directional optical transceiving is enabled, and an optical transceiver including the same.

According to an aspect of the present invention, there is provided an optical transmitter including a semiconductor laser diode to output optical signals; a multilayer thin film filter to receive the optical signals and pass optical signals corresponding to a transmission wavelength band; and a concave lens to collect the optical signals passed through the multilayer thin film filter.

According to another aspect of the present invention, there is provided an optical transceiver including an optical transmitter configured such that optical signals output from a semiconductor laser diode pass through a multilayer thin film filter and configured to include a concave lens to collect the optical signals passed through the multilayer thin film filter; an optical receiver to receive optical signals input to the optical transceiver; and a beam splitter to separate the optical signals output from the optical transmitter and the optical signals input to the optical receiver from each other.

According to another aspect of the present invention, there is provided an optical transmitter including a semiconductor laser diode to output optical signals; a multilayer thin film filter to receive the optical signals and pass optical signals corresponding to a transmission wavelength band; and a concave mirror to collect the optical signals passed through the multilayer thin film filter in a direction toward the semiconductor laser diode.

According to another aspect of the present invention, there is provided an optical transceiver including an optical transmitter configured such that optical signals output from a semiconductor laser diode pass through a multilayer thin film filter and configured to include a concave mirror to collect the optical signals passed through the multilayer thin film filter in a direction toward the semiconductor laser diode; an optical receiver to receive optical signals input to the optical transceiver; and a beam splitter to separate the optical signals output from the optical transmitter and the optical signals input to the optical receiver from each other.

According to another aspect of the present invention, there is provided an optical transmitter including a semiconductor laser diode to output optical signals; a collimating lens to convert the output optical signals into optical signals of parallel rays; a multilayer thin film filter to receive the converted optical signals and pass the converted optical signals corresponding to a transmission wavelength band; and a reflection medium to receive the optical signals passed through the multilayer thin film filter.

According to another aspect of the present invention, there is provided an optical transceiver including an optical transmitter configured to convert optical signals output from a semiconductor laser diode into optical signals of parallel rays using a collimating lens, and to include a reflection medium to receive the optical signals converted and passed through the multilayer thin film filter; and an optical receiver to receive optical signals input to the optical transceiver; and a beam splitter to separate the optical signals output from the optical transmitter and the optical signal input to the optical receiver.

### EFFECT

According to embodiments of the present invention, an optical transmitter and an optical transceiver including the same may reduce size of an external resonance laser based on a multilayer thin film filter by using a collimating lens or a concave lens as a lens constituting an optical transmitter.

Additionally, according to embodiments of the present invention, an optical transmitter and an optical transceiver including the same may secure a modulation bandwidth of laser as a length of the external resonance laser is reduced, by downsizing the external resonance laser based on a multilayer thin film filter using a collimating lens or a concave lens constituting the optical transmitter.

Additionally, according to embodiments of the present invention, an optical transmitter and an optical transceiver including the same may achieve bi-directional optical transceiving by packaging an optical transmitter including an external resonance laser based on a multilayer thin film filter, which uses a collimating lens or a concave lens, and an optical receiver together. Therefore, the optical transmitter may be used as a low price optical transceiver in a wired network optical subscriber terminal or a separate base station of a wired and wireless integrated network.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an optical transmitter including a concave lens, according to an embodiment of the present invention;

FIG. 2 is a diagram illustrating an optical transceiver including a concave lens, according to an embodiment of the present invention;

FIG. 3 is a diagram illustrating an optical transceiver including a concave lens, according to another embodiment of the present invention;

FIG. 4 is a diagram illustrating an optical transmitter including a concave mirror, according to an embodiment of the present invention;

FIG. 5 is a diagram illustrating an optical transceiver including a concave mirror, according to an embodiment of the present invention;

FIG. 6 is a diagram illustrating an optical transceiver including a concave mirror, according to another embodiment of the present invention; and

FIG. 7 is a diagram illustrating an optical transmitter including a collimating lens, according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Since specific structures or functions in the following description are illustrated only by way of example to help understanding of the embodiments. Therefore, the invention should not be construed as being limited to the embodiments set forth herein.

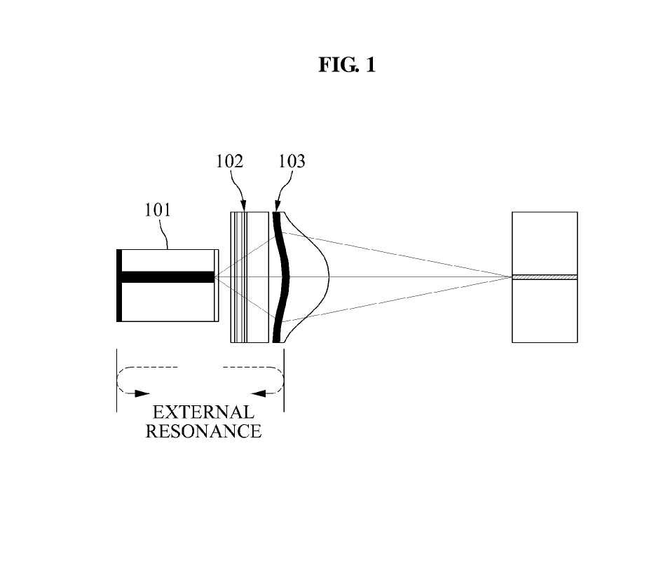

FIG. 1 is a diagram illustrating an optical transmitter including a concave lens, according to an embodiment of the present invention.

The optical transmitter shown in FIG. 1 is applicable to wavelength division multiplexing (WDM). In this case, the optical transmitter may be used in a wired network optical subscriber terminal or a separate base station of a wired and wireless integrated network using the WDM, by accommodating a unique wavelength.

In detail, referring to FIG. 1, the optical transmitter may include a semiconductor laser diode 101, a multilayer thin film filter 102, and a concave lens 103.

The semiconductor laser diode 101, as a gain medium, may output optical signals. Depending on circumstances, the semiconductor laser diode 101 may be replaced with a semiconductor optical amplifier. Anti-reflection coating may be applied to an emission surface of the semiconductor laser diode 101 whereas high-reflection coating is applied to a rear surface of the semiconductor laser diode 101. The semiconductor laser diode 101 may form an external resonator in combination with the multilayer thin film filter 102 and the concave lens 103.

The multilayer thin film filter 102 may receive the optical signals output from the semiconductor laser diode 101 and pass optical signals corresponding to a transmission wavelength band. One side of the multilayer thin film filter 102 may be coated with a multilayer thin film while an opposite side is coated with anti-reflection coating. The multilayer thin film filter 102 may be disposed between the semiconductor laser diode 101 and the concave lens 103.

The concave lens 103 may collect the optical signals passed through the multilayer thin film filter 102. In particular, the concave lens 103 may be partial coated lens partially coated with reflection coating. In the partial coated lens, the partial reflection coating may be applied to a concavo-convex lens, a convex-concavo lens, or a combined plano-concavo lens and double convex lens. Alternatively, the concave lens 103 may be coated with total reflection coating.

The above-configured optical transmitter may secure a modulation bandwidth of laser as a length of the external resonator is reduced, by downsizing an external resonance laser.

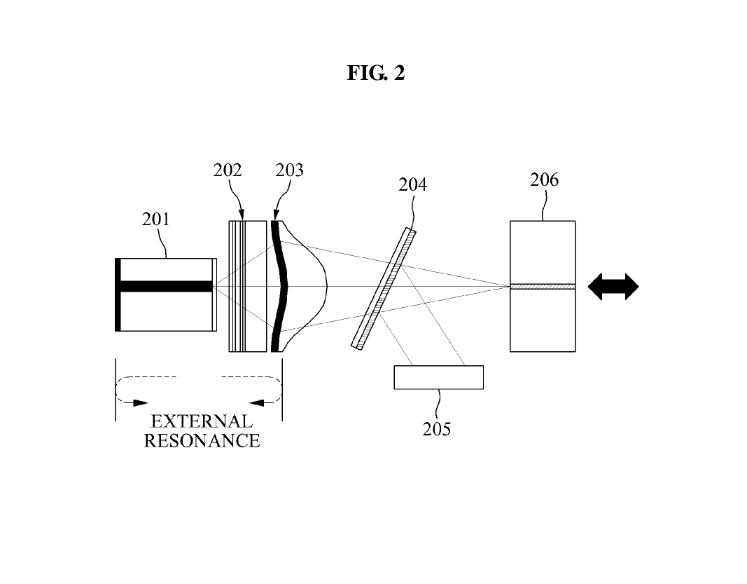

FIG. 2 is a diagram illustrating an optical transceiver including a concave lens 203, according to an embodiment of the present invention.

As shown in FIG. 2, the optical transceiver may include an optical receiver 205 and a beam splitter 204. An optical transmitter may include a laser diode 201, a multilayer thin film filter 202, and the concave lens 203. In this case, the optical transceiver may perform bi-directional optical transceiving using external resonation based on the multilayer thin film filter 202 using the concave lens 203.

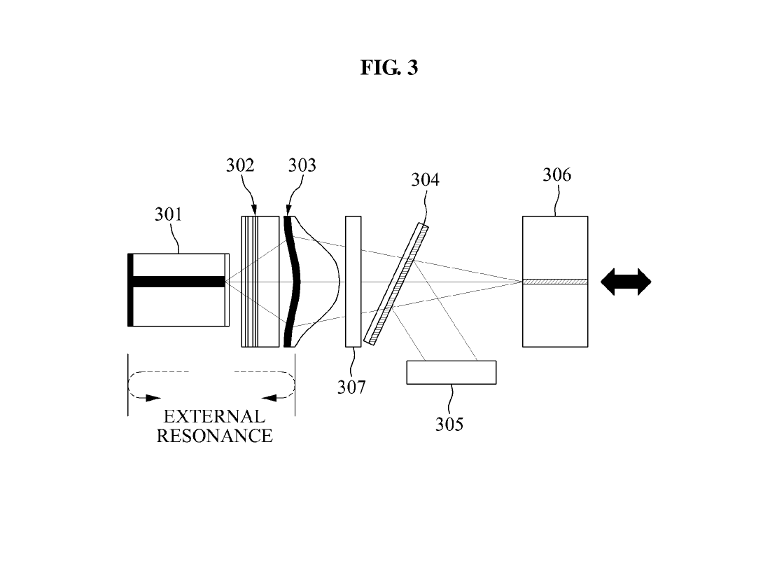

FIG. 3 is a diagram illustrating an optical transceiver including a concave lens 303, according to another embodiment of the present invention.

In addition, referring to FIG. 3, the optical transceiver may include an optical transmitter and optical receiver, a beam splitter 304, and an isolator 307. The optical transmitter may include a semiconductor laser diode 301, a multilayer thin film filter 302, and the concave lens 303. The isolator 307 may prevent the optical signals output from the optical transmitter from being partially reflected and incident again to the optical transmitter.

The above-configured optical transmitter may collect the optical signals passed through the multilayer thin film filter 302 using the concave lens 303, and output the collected optical signal to an optical fiber, thus achieving downsizing of the external resonance laser. In addition, according to the downsizing of the external resonance laser, the optical transceiver may directly perform modulation at an increased speed.

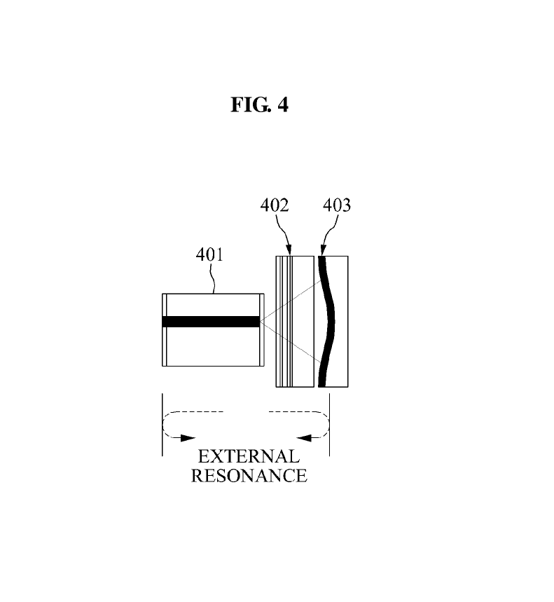

FIG. 4 is a diagram illustrating an optical transmitter including a concave mirror 403, according to an embodiment of the present invention.

The optical transmitter shown in FIG. 4 is applicable to the WDM, that is, to a wired network optical subscriber terminal or a separate base station of a wired and wireless integrated network that applies the WDM.

Referring to FIG. 4, the optical transmitter may include a semiconductor laser diode 401, a multilayer thin film filter 402, and the concave mirror 403.

The concave lens 403 may be implemented by coating a concave lens with total reflection coating rather than partial reflection coating. The semiconductor laser diode 401, as a gain medium, may output optical signals. Depending on circumstances, the semiconductor laser diode 401 may be replaced with a semiconductor optical amplifier. In addition, the semiconductor laser diode 401 may form an external resonator in combination with the multilayer thin film filter 402 and the concave lens 403.

The multilayer thin film filter 402 may receive the optical signals output from the semiconductor laser diode 401 and pass optical signals corresponding to a transmission wavelength band. The transmission wavelength band of the multilayer thin film filter 402 may be newly defined by the concave mirror 403. The multilayer thin film filter 402 may be disposed between the semiconductor laser diode 401 and the concave minor 403. An output of the optical transmitter may be output to a back facet of the semiconductor laser diode 401.

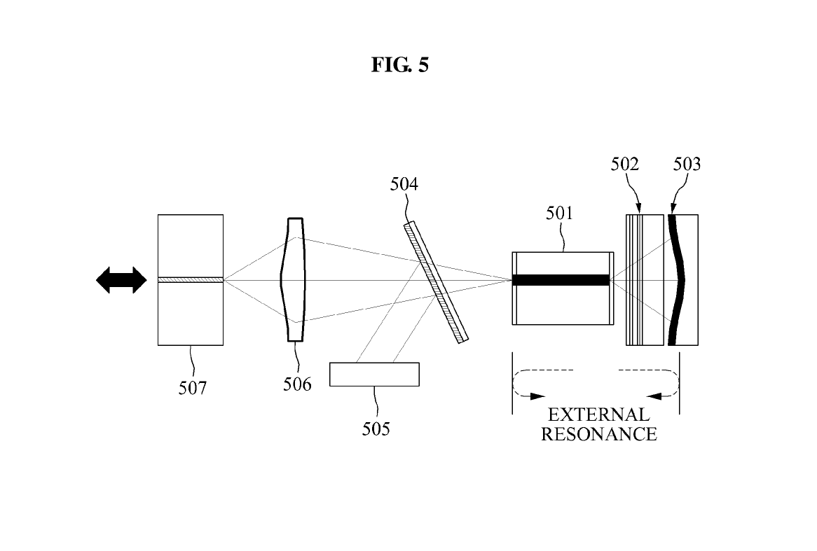

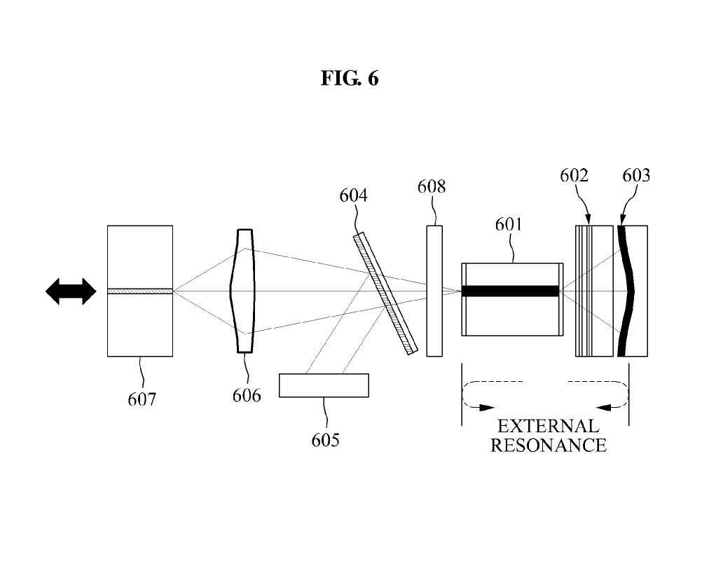

FIG. 5 is a diagram illustrating an optical transceiver including a concave minor 503, according to an embodiment of the present invention. FIG. 6 is a diagram illustrating an optical transceiver including a concave mirror 603, according to another embodiment of the present invention.

As shown in FIG. 5, the optical transceiver may include an optical transmitter and optical receiver 505, and a beam splitter 504. The optical transmitter may include a semiconductor laser diode 501, a multilayer thin film filter 502, and a concave mirror 503. Here, the optical transceiver may perform bi-directional optical transceiving using external resonance based on the multilayer thin film filter 502 using the concave mirror 503.

In addition, as shown in FIG. 6, the optical transceiver may include an optical transmitter and optical receiver 605, a beam splitter 604, and an isolator 608. The optical transmitter may include a semiconductor laser diode 601, a multilayer thin film filter 602, and a concave mirror 603. The isolator 608 may prevent the optical signals output from the optical transmitter from being partially reflected and incident again to the optical transmitter.

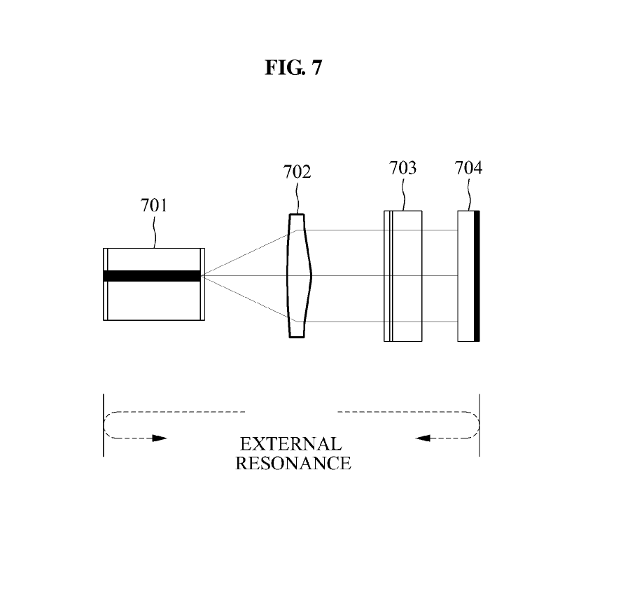

FIG. 7 is a diagram illustrating an optical transmitter including a collimating lens, according to an embodiment of the present invention. The optical transmitter may be used in a wired network optical subscriber terminal or a separate base station of a wired and wireless integrated network that applies the WDM.

Referring to FIG. 7, the optical transmitter may include a semiconductor laser diode 701, a collimating lens 702, a multilayer thin film filter 703, and a reflection medium 704.

The semiconductor laser diode 701, as a gain medium, may output optical signals. Anti-reflection coating may be applied to an emission surface of the semiconductor laser diode 701 whereas high-reflection coating is applied to a rear surface of the semiconductor laser diode 701.

The collimating lens 702 may receive optical signals output from the semiconductor laser diode 701. In addition, the collimating lens 702 may convert the received optical signals into optical signals of parallel rays. The optical signals of parallel rays may maintain the parallel rays with reference to an axis of the collimating lens 702.

The multilayer thin film filter 703 may receive the converted optical signals from the collimating lens 702 and pass converted optical signals corresponding to a transmission wavelength band. One side of the multilayer thin film filter 703 may be coated with a multilayer thin film while an opposite side is coated with anti-reflection coating. A transmission wavelength spectrum of the multilayer thin film filter 703 may be expressed by a Lorentzian shape or a narrow band Gaussian shape. A thin film of the multilayer thin film filter 703 may be designed so that the transmission wavelength spectrum is expressed by the Lorentzian shape.

The semiconductor laser diode 701 may form an external resonator in combination with the multilayer thin film filter 703, the collimating lens 702, and the reflection medium 704. An output wavelength of external resonance laser may be determined by resonance conditions of the external resonator and transmission characteristics of the multilayer thin film filter 703. Here, emission of the optical output of the external resonance laser may be directed to a rear side of the semiconductor laser diode 701 or a rear side of the reflection medium 704. When the optical output of the external resonance laser is directed to the rear side of the reflection medium 704, the reflection medium 704 may be coated with partial reflection coating.

Although not shown in the drawings, the optical transceiver may include an optical transmitter and optical receiver, and a beam splitter. The optical transmitter may include the semiconductor laser diode 701, the collimating lens 702, the multilayer thin film filter 703, and the reflection medium 704. The optical transceiver may perform bi-directional optical transceiving using external resonance based on the multilayer thin film filter 703 using the collimating lens 702.

Additionally, although not shown, the optical transceiver may include an optical transmitter and optical receiver including the collimating lens 702, a beam splitter, and an isolator. The isolator may prevent optical signals output from the optical transmitter from being incident again to the optical transmitter.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An optical transmitter comprising:
a semiconductor laser diode to output optical signals;
a multilayer thin film filter to receive the optical signals and pass optical signals corresponding to a transmission wavelength band; and
a concave lens to collect the optical signals passed through the multilayer thin film filter.

2. The optical transmitter of claim 1, wherein the concave lens is a partial coated lens comprising any of a coated concavo-convex lens, a coated convex-concavo lens, a coated convex-concavo lens, and a combination of a plano-concavo lens and double convex lens.

3. The optical transmitter of claim 1, wherein
the concave lens is disposed apart from the multilayer thin film filter, and
the multilayer thin film filter is disposed apart from the semiconductor laser diode.

4. An optical transceiver comprising:
an optical transmitter configured such that optical signals output from a semiconductor laser diode pass through a multilayer thin film filter and configured to include a concave lens to collect the optical signals passed through the multilayer thin film filter;
a beam splitter to separate the optical signals output from the optical transmitter and the optical signals input to the optical receiver from each other; and an optical receiver to receive optical signals input to the optical transceiver.

5. The optical transceiver of claim 4, wherein the optical transceiver further comprises:
an isolator to prevent the optical signals output from the optical transmitter from being partially reflected and incident again to the optical transmitter.

6. An optical transmitter comprising:
a semiconductor laser diode to output optical signals;
a multilayer thin film filter to receive the optical signals and pass optical signals corresponding to a transmission wavelength band; and
a concave mirror to collect the optical signals passed through the multilayer thin film filter in a direction toward the semiconductor laser diode.

7. The optical transmitter of claim 6, wherein
the concave mirror is disposed apart from the multilayer thin film filter, and
the multilayer thin film filter is disposed apart from the semiconductor laser diode.

8. An optical transceiver comprising:
an optical transmitter configured such that optical signals output from a semiconductor laser diode pass through a multilayer thin film filter and configured to include a concave mirror to collect the optical signals passed through the multilayer thin film filter in a direction toward the semiconductor laser diode;
a beam splitter to separate the optical signals output from the optical transmitter and the optical signals input to the optical receiver from each other; and an optical receiver to receive optical signals input to the optical transceiver.

9. The optical transceiver of claim 8, further comprising
a lens to collect optical signals output from an opposite direction of the semiconductor laser diode.

10. The optical transceiver of claim 9, wherein the lens is disposed on an opposite side to the concave mirror with respect to the semiconductor laser diode.

11. The optical transceiver of claim 8, further comprising an isolator to prevent the optical signals output from the optical transmitter from being partially reflected and incident again to the optical transmitter.

12. An optical transmitter comprising:
a semiconductor laser diode to output optical signals;
a collimating lens to convert the output optical signals into optical signals of parallel rays;
a multilayer thin film filter to receive the converted optical signals and pass the converted optical signals corresponding to a transmission wavelength band; and
a reflection medium to receive the optical signals passed through the multilayer thin film filter.

13. The optical transmitter of claim 12, wherein the transmission wavelength spectrum of the multilayer thin film filter has a Lorentzian shape or a narrow band Gaussian shape.

14. An optical transceiver comprising:
an optical transmitter configured to convert optical signals output from a semiconductor laser diode into optical signals of parallel rays using a collimating lens, and to include a reflection medium to receive the optical signals converted and passed through the multilayer thin film filter; and
a beam splitter to separate the optical signals output from the optical transmitter and the optical signals input to the optical receiver from each other; and an optical receiver to receive optical signals input to the optical transceiver.

15. The optical transceiver of claim 14, further comprising an isolator to prevent the optical signals output from the optical transmitter from being partially reflected and incident again to the optical transmitter.

16. The optical transceiver of claim 14, wherein the transmission wavelength spectrum of the multilayer thin film filter has a Lorentzian shape or a narrow band Gaussian shape.
